(19) United States
(12) Patent Application Publication
(10) Pub. No.: US 2005/0002702 A1
(43) Pub. Date: Jan. 6, 2005

(54) Image forming apparatus and transfer belt

(75) Inventor: Yoshitsugu Nakatomi, Kanagawa-ken (JP)

Correspondence Address: FOLEY AND LARDNER;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/862,475

(22) Filed: Jun. 8, 2004

(30) Foreign Application Priority Data
Jul. 1, 2003 (JP) 2003-189558

(51) Int. Cl. G03G 15/01

(52) U.S. Cl. 399/301; 399/302

(57) ABSTRACT

In an image forming apparatus, rollers to stretch and suspend a transfer belt to which color images are transferred are equipped with small diameter portions and a marker is formed, the marker facing to the small diameter portions sequentially when the transfer belt runs.

### CROSS-REFERENCE TO RELATED APPLICATION

This application is based upon and claims the benefit of priority from the prior Japanese Patent Application No. 2003-189558 filed on Jul. 1, 2003; the entire contents of which are incorporated herein by reference.

### BACKGROUND OF THE INVENTION

1. Field of the Invention

The present invention relates to an image forming apparatus and a transfer belt for forming a multi-color developed image on a recording medium using an intermediate transfer device.

2. Description of the Related Art

There is an image forming apparatus available for obtaining color images by an electro-photographic method such as a color copier or a color printer. In such an apparatus, to realize miniaturization of the apparatus, a primary transfer of rotating a photoconductor several times and superimposing different toner images of respective colors formed every rotation on an endless transfer belt is performed and full-color images are obtained. Thereafter, the full-color images are secondarily transferred to a recording medium in a batch. In an apparatus using a transfer belt for this primary transfer, the transfer belt has a marker installed. The apparatus detects the marker, thereby takes the image forming timing, and accurately superimposes full-color images.

The marker detection remarkably affects the image quality, so that high accuracy is required. Therefore, conventionally, for example, as disclosed in Japanese Patent Publication No. 2002-31927, a marker is installed on the inner peripheral surface of the transfer belt, thus the marker is prevented from damage due to adhering of splashed toner and paper powder in the image forming apparatus to the marker.

However, as disclosed in Japanese Patent Application 2002-31927, when the marker is installed on the inner peripheral surface of the transfer belt, there is the possibility that due to contact with a plurality of rollers for stretching and suspending the transfer belt, the marker may be damaged or misdetection may be caused by deterioration of the marker due to frictional wear.

### SUMMARY OF THE INVENTION

An object of the present invention is to provide an image forming apparatus and a transfer belt, without impairing the detection accuracy of a marker installed on the inner peripheral surface of a transfer belt whereon toner images of a plurality of colors are superimposed, for preventing the marker from damage, detecting accurately the marker, thereby realizing high color superimposition accuracy, and obtaining color images with high image quality.

According to the embodiment of the present invention, an image forming apparatus is provided and the apparatus comprises an image carrying member, a developing portion for forming developed images of a plurality of colors on the image carrying member, an endless transfer belt installed opposite to the transfer position of the image carrying member whereon the developed images of a plurality of colors formed on the image carrying member are sequentially transferred and the developed images of a plurality of colors are superimposed, a plurality of support rollers having partially formed small diameter portions for stretching and suspending the transfer belt, markers installed at the parts opposite to the small diameter portions of the plurality of support rollers on the inner peripheral surface of the transfer belt, a detecting portion for detecting the markers, a controlling portion for controlling the superimposition position of the developed images of a plurality of colors on the transfer belt by the detection result from the detecting device, and a secondary transferring portion for transferring secondarily the developed images of a plurality of colors superimposed on the transfer belt to a recording medium in a batch.

Furthermore, according to the embodiment of the present invention, a transfer belt is provided and the transfer belt comprises an endless belt base whereon developed images of a plurality of colors are sequentially transferred and the developed images of a plurality of colors are superimposed, hollow level different portions formed on the inner peripheral surface of the endless belt base, and markers installed in the level different portions.

### BRIEF DESCRIPTION OF THE DRAWINGS

Other object and many of the attendant advantages of the present invention will be readily appreciated as the same becomes better understood by reference to the following detailed description when considered in connection with the accompanying drawings, in which like reference characters designate the same or similar parts throughout the figures thereof and wherein:

FIG. 1 is a schematic cross sectional view showing schematically the image forming apparatus of the present invention;

FIG. 2 is a front view showing schematically the transfer belt of the present invention;

FIG. 3 is a perspective view showing schematically a driving roller, a driven roller, and a tension roller for stretching and suspending the transfer belt;

FIG. 4 is a plan view showing the arrangement relationship between the transfer belt, driving roller, driven roller, and tension roller;

FIG. 5 is a block diagram showing schematically a controlling system for controlling the image forming timing for color superimposition;

FIG. 6 is a front view showing schematically the second embodiment of the transfer belt of the present invention;

FIG. 7 is a schematic diagram showing the arrangement relationship between the transfer belt, driving roller, driven roller, and tension roller as a third embodiment of the present invention;

FIG. 8 is an illustration showing the arrangement relationship between the transfer belt, driving roller, driven roller, and tension roller as a fourth embodiment of the present invention; and

FIG. 9 is an enlarged view showing a modification of the support roller.

### DETAILED DESCRIPTION OF THE INVENTION

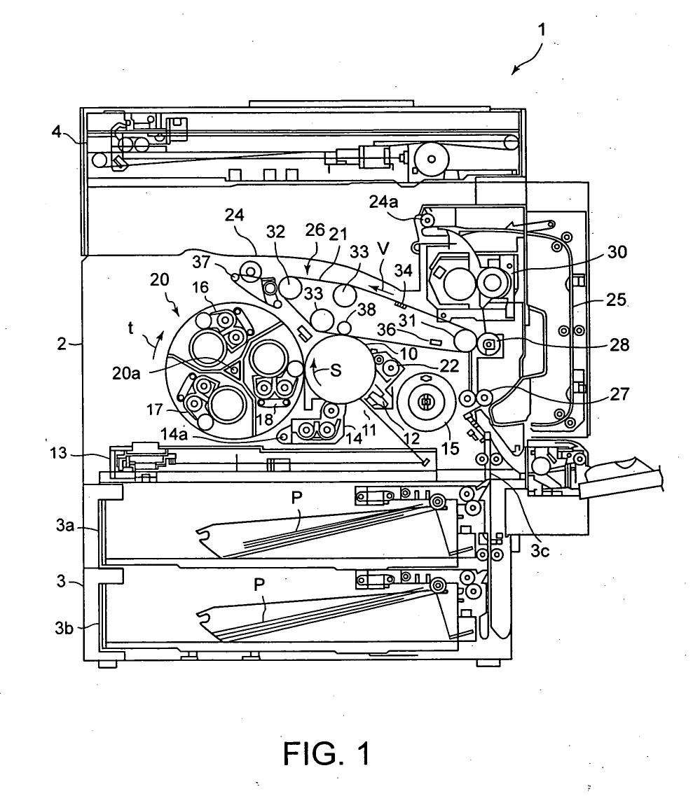

The present invention will be explained in detail below with reference to the first embodiment shown in FIGS. 1 to 5.

FIG. 1 is a schematic block diagram showing the whole of image forming apparatus 1 such as a color printer relating to the first embodiment of the present invention. Image forming apparatus 1 internally has paper supply devices 3 for supplying papers that are recording media toward image forming portion 2. Paper supply devices 3 take out papers P from paper supply cassettes 3a and 3b and supply papers P toward aligning roller 27 along conveying path 3c. On the top of image forming apparatus 1, scanner 4 for reading document images is installed.

Around photosensitive drum 10, which is an image carrier, of image forming portion 2, developing portion 11 for forming toner images of a plurality of colors, which are developed images, on photosensitive drum 10 is installed. In developing portion 11, main charger 12 for uniformly charging photosensitive drum 10 sequentially in the rotational direction of the arrow s of photosensitive drum 10, laser exposure 13 for forming latent images on charged photosensitive drum 10 on the basis of image data from scanner 4, and color developing device 20 of a revolver type loading black developing unit 14, yellow (Y) developing unit 16, magenta (M) To black developing unit 14, toner is supplied from black toner bottle 15. Color developing device 20 sequentially rotates in the direction of the arrow t around rotation axis 20a, arranges yellow (Y), magenta (M), and cyan (C) developing units 16 to 18 opposite to photosensitive drum 10, and sequentially supplies toners of yellow (Y), magenta (M), and cyan (C) to photosensitive drum 10.

Around photosensitive drum 10, transfer belt device 26 having transfer belt 21 and cleaner 22 are arranged.

Image forming portion 2 is equipped with secondary transferring roller 28 for secondarily transferring toner images of a plurality of colors superimposed on transfer belt 21 to paper P, fixing device 30 for fixing toner images on paper P, and exit roller 24a for ejecting paper P to paper exit 24 after fixing.

Image forming portion 2 has reversing path 25 for reversing paper P at the time of double-side image forming.

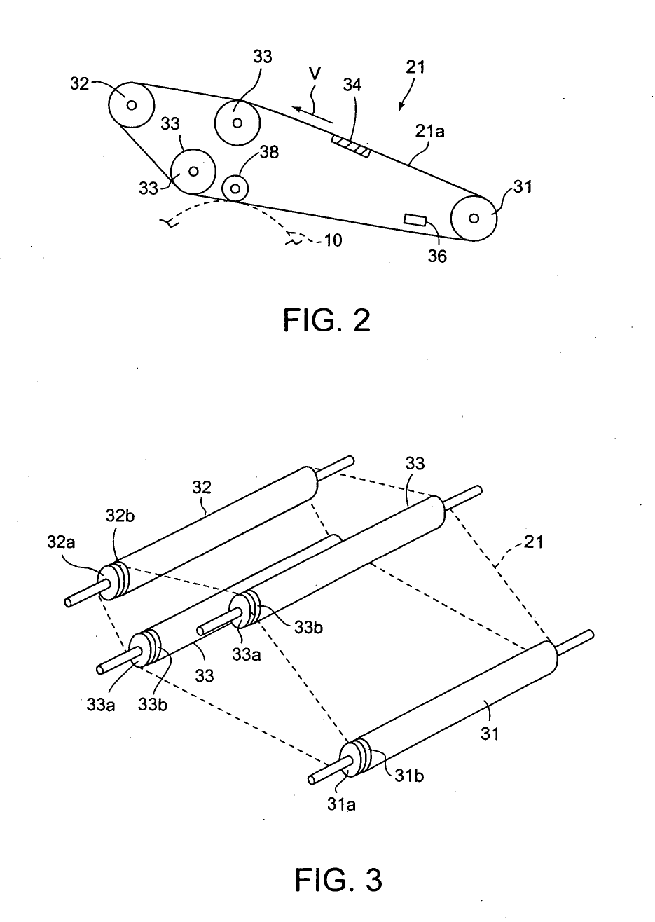

Transfer belt device 26 will be described below. Transfer belt 21, as shown in FIG. 2, are stretched and suspended by a plurality of support rollers such as driving roller 31, driven roller 32, and tension rollers 33. Transfer belt 21 is formed by a material such as polyimide. The electric resistance VR (Ω·cm) of transfer belt 21 has a desirable range as follows:
9.2≦Log₁₀VR≦10.2

If the electric resistance VR of transfer belt 21 has within the range as mentioned above, the toner image on photosensitive drum 10 can be transferred sufficiently onto transfer belt 21 at the primary transferring position. range as mentioned above, the toner image on photosensitive drum 10 can be transferred sufficiently onto transfer belt 21 at the primary transferring position.

If Log₁₀VR has a value lower than 9.2, much current flows inside transfer belt 21 and many electric charges will be given to the toner too much. Therefore, the toner is reverse-charged and the toner image cannot transfer sufficiently onto transfer belt 21 from photosensitive drum 10.

If Log₁₀VR has a value higher than 10.2, a few current will flow inside transfer belt 21. Therefore, sufficient electric charge for the toner is not given, resulting the toner image cannot transfer sufficiently onto transfer belt 21 from photosensitive drum 10.

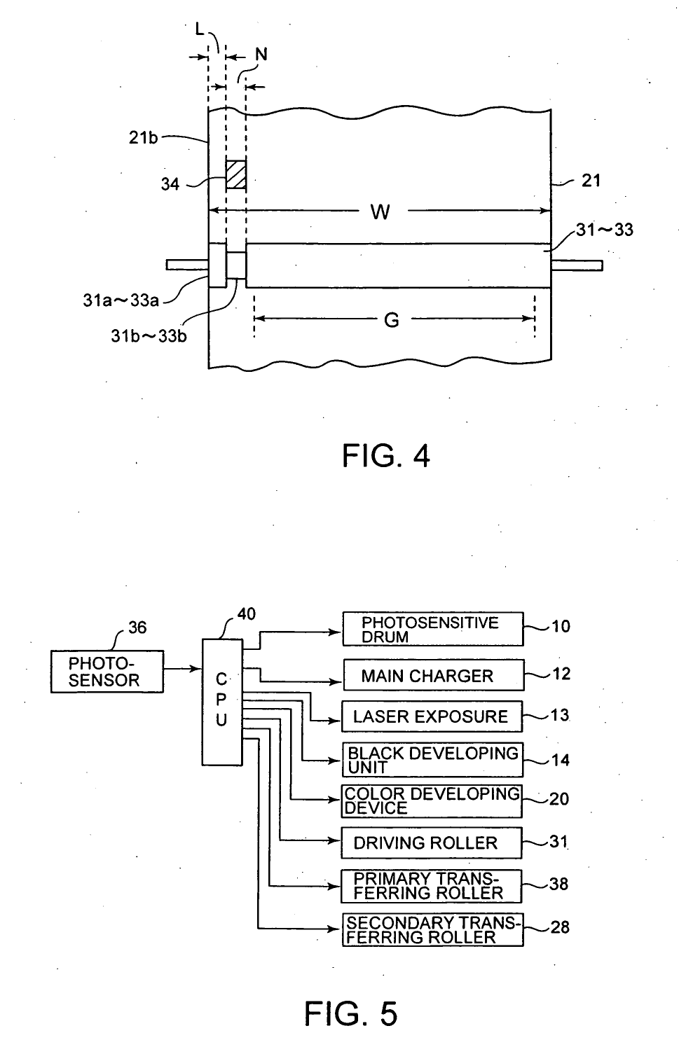

Transfer belt 21 itself is black. Each of rollers 31 to 33 has a length almost equal to width W of the transfer belt. As shown in FIGS. 3 and 4, at the positions at a distance of L from edges 31a to 33a on one side of rollers 31 to 33, small diameter portions 31b to 33b with a width of N and a diameter smaller than the diameters of both sides thereof are formed. By small diameter portions 31b to 33b, level differences are formed on the surfaces of rollers 31 to 33.

The transfer belt is equipped with printed markers 34, as shown in FIG. 4, installed at the parts opposite to small diameter portions 31b to 33b of rollers 31 to 33 on the inner peripheral surface of endless belt base 21a. Marker 34 is formed at the position at a distance of L inside from side edge 21b of the transfer belt. The printing position of marker 34 is outside transferring area G on transfer belt 21. At the position opposite to marker 34, reflection type photo-sensor 36 that is a detecting portion for detecting marker 34 is arranged. Marker 34, for example, is belt base 21a whereon zinc oxide particles are coated flatly. Marker 34 may be formed by printing. Zinc oxide is higher in whiteness than regular copy papers, so that the light reflectance is high and the detection accuracy is high.

Transfer belt 21 is stretched and suspended and rotated between rollers 31 to 33, though markers 34 do not make contact with rollers 31 to 33 due to the level differences formed by small diameter portions 31b to 33b of rollers 31 to 33. Reference numeral 37 indicates a belt cleaner (refer to FIG. 1).

The primary transferring position where transfer belt 21 makes contact with photosensitive drum 10 is supported by primary transferring roller 38 for applying a primary transferring bias voltage. To the secondary transferring position where transfer belt 21 is supported by driving roller 31, secondary transferring roller 28 whereto the secondary transferring bias voltage is applied is opposite.

FIG. 5 is a block diagram showing the controlling system for controlling the image forming timing to superimpose toner images of a plurality of colors on transfer belt 21. To CPU 40 that is a controlling portion for controlling whole image forming apparatus 1, marker detection results by photo-sensor 36 are input. To the output side of CPU 40, photosensitive drum 10, main charger 12, laser exposure 13, black developing unit 14, color developing device 20, driving roller 31, primary transferring roller 38, and secondary transferring roller 28 are connected.

CPU 40, every forming of toner images of a plurality of colors, receives detection results of markers 34 from photo-sensor 36. Upon receipt of the detection results, CPU 40 drives and controls photosensitive drum 10, main charger 12, laser exposure 13, black developing unit 14, color developing device 20, primary transferring roller 38, and secondary transferring roller 28, and superimposes toner images of a plurality of colors at the same position on transfer belt 21, thereby controls so as to transfer a full-color image.

An image forming process by image forming apparatus 1 will be explained below. Image forming apparatus 1 superimposes toner images in the order of yellow (Y), magenta (M), cyan (C), and black (BK) on paper P, thereby obtains a full-color image. Therefore, developing portion 11 forms toner images in the order of black (BK), cyan (C), magenta (M), and yellow (Y).

When the image forming process starts, scanner 4 reads document R and the read information is sent to CPU 40. Image forming portion 2 drives photosensitive drum 10 and main charger 12, simultaneously drives driving roller 31 of transfer belt device 26, and rotates transfer belt 21 in the direction of arrow v. During this period, black developing unit 14 is moved to the position ready for developing. When the detection results of markers 34 are input to CPU 40 by photo-sensor 36, a laser beam according to a black image signal of document R is irradiated to photosensitive drum 10 rotating in the direction of arrow s by laser exposure 13 and a black electrostatic latent image is formed on photosensitive drum 10.

The black electrostatic latent image is developed by black developing unit 14 and a black (BK) toner image is formed on photosensitive drum 10. When the black (BK) toner image on photosensitive drum 10 reaches the primary transferring position which is a contact position with transfer belt 21 rotating in the direction of arrow v, it is primarily transferred onto transfer belt 21 by application of the transfer bias voltage from primary transferring roller 38. After the primary transfer, the residual toner on photosensitive drum 10 is cleaned by cleaner 22.

Thereafter, for each color of each toner image, by keeping synchronization with the image forming timing on the basis of the detection of markers 34 from photo-sensor 36, in the same way as with the black (BK) toner image forming process, the toner image forming process is repeated in the order of cyan (C), magenta (M), and yellow (Y) and toner images of a plurality of colors are superimposed at the same position on transfer belt 21. At this time, black developing unit 14 is separated from photosensitive drum 10 and color developing device 20 rotates in the direction of arrow t in correspondence to arrival of an electrostatic latent image of each color and sequentially arranges cyan (C) developing unit 18, magenta (M) developing unit 17, and yellow (Y) developing unit 16 opposite to photosensitive drum 10.

Namely, when the black (BK) toner image is primarily transferred onto transfer belt 21 and then photo-sensor 36 detects marker 34, CPU 40 starts the image forming process of cyan (C). The cyan (C) toner image formed on photosensitive drum 10 is superimposed on the black toner image of transfer belt 21 rotating in the direction of arrow v and is primarily transferred.

Similarly, whenever marker 34 is detected by photo-sensor 36, CPU 40 repeats toner image forming on photosensitive drum 10 and toner image transfer to transfer belt 21. And, on transfer belt 21 whereon black (BK) and cyan (C) toner images are formed, CPU 40 superimposes magenta (M) and yellow (Y) toner images and forms a full-color toner image on transfer belt 21.

Thereafter, when the full-color toner image of black (BK), cyan (C), magenta (M), and yellow (Y) superimposed on transfer belt 21 reaches the secondary transferring position, by the transfer bias voltage of secondary transferring roller 28, the full-color toner image on transfer belt 21 is secondarily transferred onto paper P in a batch. Paper P, in synchronization with arrival of the full-color toner image on transfer belt 21 at the secondary transferring position, is conveyed from paper supply device 3 to the secondary transferring position. Hereafter, paper P, after the full-color toner image is fixed by fixing device 30 and the color image is completed, is accumulated in paper exit 24. On the other hand, after end of transfer to paper P, the residual toner of transfer belt 21 is cleaned by cleaner 37.

During such repetition of the image forming process, markers 34 do not make contact with rollers 31 to 33, are not subject to wear and damage, and are satisfactorily detected by photo-sensor 36.

According to the first embodiment of the present invention mentioned above, in rollers 31 to 33 for stretching and suspending transfer belt 21, small diameter portions 31b to 33b are formed, thus markers 34 on the inner peripheral surface of transfer belt 21 are prevented from contact with rollers 31 to 33. Therefore, markers 34 are not deteriorated due to wear and damage and can be detected with high accuracy over a long period of time. By doing this, a color image of high image quality in which toner images of a plurality of colors are superimposed at the same position of transfer belt 21 with high accuracy can be obtained. Further, small diameter portions 31b to 33b are positioned outside transferring area G of transfer belt 21, so that there is no possibility that they may affect transferred images.

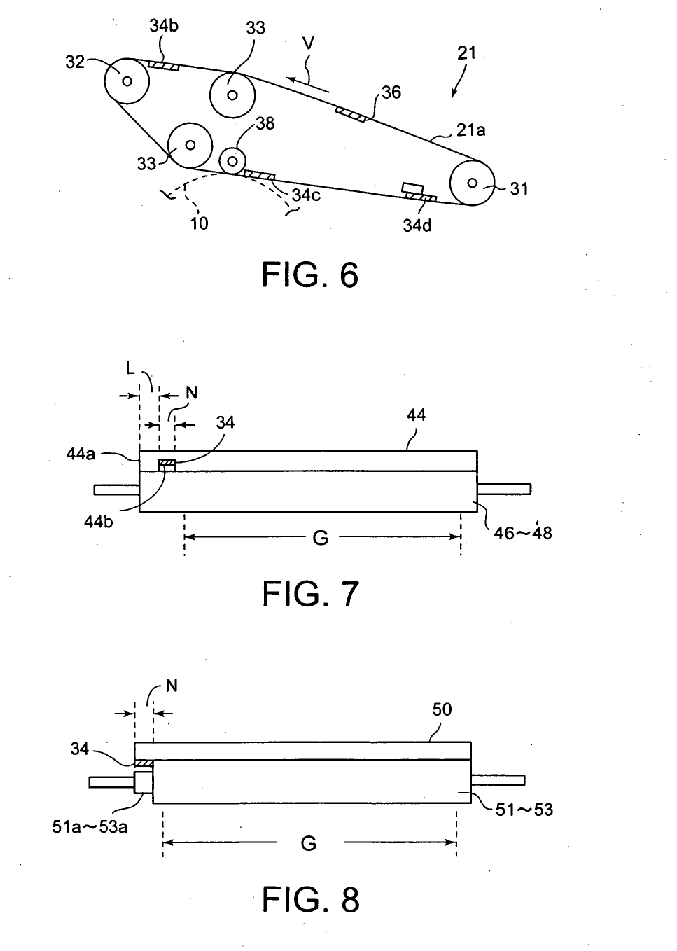

Next, the second embodiment of the present invention will be explained below. The second embodiment is a one in which a plurality of markers are installed on the transfer belt in the first embodiment, and to the same parts as those of the constitution explained in the first embodiment, the same numerals are assigned, and the detailed explanation thereof will be omitted. As shown in FIG. 6, seamless transfer belt 42, similarly to the first embodiment, is stretched and suspended by driving roller 31, driven roller 32, and tension rollers 33.

At the four positions corresponding to small diameter portions 31b to 33b of rollers 31 to 33, markers 34a to 34d are printed at a predetermined interval. During the image forming process by image forming apparatus 1, on the basis of detection of any one marker 34 among markers 34a to 34d printed at the four positions whenever a full-color image is formed, in synchronization with the image forming timing, toner images of black (BK), cyan (C), magenta (M), and yellow (Y) are superimposed on transfer belt 21 and a full-color toner image is formed.

Actually, when the image forming process starts, thus transfer belt 21 starts rotation in the direction of arrow v, an optional marker detected by photo-sensor 36 first, for example, marker 34b is set as a marker for taking the superimposition timing of toner images of various colors. Namely, whenever photo-sensor 36 detects marker 34b, CPU 40 repeats toner image forming on photosensitive drum 10 and toner image transfer to transfer belt 21, primarily transfers sequentially toner images of black (BK), cyan (C), magenta (M), and yellow (Y) onto transfer belt 21, superimposes them on transfer belt 21, and forms a full-color toner image. Hereafter, the full-color toner image superimposed on transfer belt 21 is secondarily transferred onto paper P inserted between transfer belt 21 and secondary transferring roller 28 in a batch. Furthermore, paper P is accumulated on paper exit 24 after fixing and the image forming process is finished.

When a new imaging forming process is started next, transfer belt 21 is rotated in the direction of arrow v and an optional marker for taking the superimposition timing of toner images is detected by photo-sensor 36. For example, when the preceding image forming process is finished, if the intermediate area between markers 34c and 34d is positioned at the position of photo-sensor 36, when the new image forming process is started, marker 34d is detected first by photo-sensor 36. Therefore, CPU 40 sets marker 34d detected first as a marker for taking the superimposition timing of toner images of various colors. Namely, whenever marker 34d is detected, CPU 40 repeats toner image forming on photosensitive drum 10 and toner image transfer to transfer belt 21, superimposes toner images of black (BK), cyan (C), magenta (M), and yellow (Y) on transfer belt 21, and forms a full-color toner image.

During such repetition of the image forming process, in the same way as with the first embodiment, a plurality of markers 34a to 34d do not make contact with rollers 31 to 33, are not subject to wear and damage, and are satisfactorily detected by photo-sensor 36.

According to the second embodiment mentioned above, in the same way as with the first embodiment mentioned above, the plurality of markers 34a to 34d do not make contact with rollers 31 to 33, so that they are not deteriorated and can be detected with high accuracy over a long period of time. Therefore, a color image of high image quality in which toner images of a plurality of colors are superimposed at the same position of transfer belt 21 with high accuracy can be obtained. Further, small diameter portions 31b to 33b are positioned outside transferring area G of transfer belt 21, so that there is no possibility that they may affect transferred images.

Furthermore, according to the second embodiment, a plurality of markers 34a to 34d are installed on the inner peripheral surface of the transfer belt and among the plurality of markers 34a to 34d, using optional marker 34a to 34d reaching photo-sensor 36 first, the toner image superimposition timing can be taken. Therefore, compared with the first embodiment in which one marker 34 is installed, the time required from start of the image forming process to arrival of markers 34a to 34d at the position of photo-sensor 36 can be shortened and the image forming speed can be increased.

Next, the third embodiment of the present invention will be explained below. The third embodiment is a one in which to prevent the marker on the inner peripheral surface of the transfer belt from making contact with the rollers for stretching and suspending the transfer belt in the first embodiment, a level difference is formed on the transfer belt, and to the same parts as those of the constitution explained in the first embodiment, the same numerals are assigned, and the detailed explanation thereof will be omitted. As shown in FIG. 7, at the position at a distance of L from an end portion 44a on one side of transferring belt 44 on the inner peripheral surface of transferring belt 44, a groove 44b with a width of N that is a depressed step portion is formed. Marker 34 is printed in groove 44b. Driving roller 46, driven roller 47, and tension rollers 48 are formed in the same diameter overall the length.

According to the third embodiment mentioned above, marker 34 is formed in groove 44b of transfer belt 44, so that during repetition of the image forming process, marker 34 does not make contact with rollers 46 to 48 and is not subject to wear and damage. Therefore, in the same way as with the first embodiment, marker 34 can be detected with high accuracy over a long period of time. By doing this, a color image of high image quality in which toner images of a plurality of colors are superimposed at the same position of transfer belt 44 with high accuracy can be obtained. Further, groove 44b is positioned outside transferring area G of transfer belt 44, so that there is no possibility that it may affect transferred images.

Next, the fourth embodiment of the present invention will be explained below. The fourth embodiment is a one in which the small diameter portions of the rollers for stretching and suspending the transfer belt are installed in the edge portions of the rollers in the first embodiment, and to the same parts as those of the constitution explained in the first embodiment, the same numerals are assigned, and the detailed explanation thereof will be omitted. As shown in FIG. 8, small diameter portions 51a to 53a with a width of N are formed in the edge portions of driving roller 51, driven roller 52, and tension rollers 53 for stretching and suspending transfer belt 50 and level differences are formed in the edge portions of rollers 51 to 53.

Further, markers 34 are formed by printing at the positions corresponding to small diameter portions 51a to 53a in the edge portions of rollers 51 to 53 on the inner peripheral surface of transfer belt 50. Namely, markers 34 are formed at the side edge of transfer belt 50.

According to the fourth embodiment mentioned above, in the same way, as with the first embodiment, markers 34 on the inner peripheral surface of transfer belt 50 do not make contact with rollers 51 to 53. Therefore, markers 34 are not subject to wear and damage and can be detected with high accuracy over a long period of time. Therefore, a color image of high image quality in which toner images of a plurality of colors are superimposed at the same position of transfer belt 50 with high accuracy can be obtained. Further, small diameter portions 51a to 53a are positioned outside the transferring area of transfer belt 50, so that there is no possibility that they may affect transferred images. Toner easily leaks outside transfer belt 50, so that it is little adhered to markers 34.

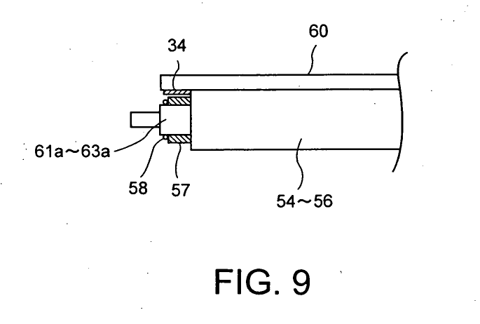

FIG. 9 shows an enlarged modification of the support roller. The material of support rollers 54 to 56 is aluminum. Into small diameter portions 61a to 63a formed in the edge portions of support rollers 54 to 56, ring rotation members 57 made of polyacetal (synthetic resin) are respectively fit rotatably. Rotation members 57 are fixed by fixing rings 58 so as to prevent from falling out from small diameter portions 61a to 63a. The outer diameter of rotation members 57 is specified so as not to make contact with markers 34 printed on transfer belt 60. By use of such a constitution, the adhesion amount of toner onto markers 34 can be reduced more.

The present invention is not limited to the aforementioned embodiments and can be changed variously within the range of the present invention. For example, the number of a plurality of developed images and color kind are not limited, and the developing portion may not be of a revolver type, and the transfer belt is not limited and the structure and size thereof are optional. However, as mentioned in the second embodiment, when the transfer belt has a plurality of markers and toner images can be transferred to an optional position of the transfer belt, a seamless transfer belt must be used.

Furthermore, the width of the small diameter portions of the support rollers for stretching and suspending the transfer belt or of the groove of the transfer belt and the size or number of markers are optional and for example, in the third embodiment, a plurality of markers may be formed in the groove formed in the transfer belt. Furthermore, only the marker forming portions may be formed in a hollow shape. However, as described in the fourth embodiment, when the markers are formed in the edge portion of the transfer belt, and the small diameter portions are formed in the edge portions of the support rollers, or the groove are formed in the edge portion of the transfer belt, if the small diameter portions or the groove are widened, during rotation of the transfer belt, the edge portion of the transfer belt flutters or waves, and the detection accuracy of the markers by the photo-sensor is varied. Therefore, the small diameter portions in the edge portions of the sup port rollers or the groove in the edge portion of the transfer belt must be narrowed so as to prevent the transfer belt from fluttering and waving.

As described in the first embodiment or the third embodiment, when the small diameter portions of the support rollers or the groove of the transfer belt are formed inside the side edge thereof, there is no possibility of fluttering or waving of the marker forming portions of the transfer belt. Therefore, the width of the small diameter portions of the support rollers or of the groove of the transfer belt is optional as long as it does not adversely affect the transfer capacity of toner images.

As described above in detail, according to the present invention, the markers formed on the inner peripheral surface of the transfer belt are structured so as not to make contact with the support rollers for stretching and suspending the transfer belt, so that the markers can be prevented from deterioration due to wear and damage. Therefore, over a long period of time, the markers can be detected with high accuracy, and the superimposition accuracy of toner images of a plurality of colors on the transfer belt can be improved, and an image forming apparatus of improved image quality of color images can be obtained.

1. An image forming apparatus, comprising:
an image carrier;
a developing portion to form developed images of a plurality of colors on the image carrier;
an endless transfer belt provided opposite to a primary transferring position of the image carrier whereon the developed images formed on the image carrier are sequentially transferred and the developed images of the plurality of colors are superimposed;
a plurality of support rollers having partially formed small diameter portions to stretch and suspend the transfer belt;
a marker provide on the inner surface of the transfer belt, the marker facing to the small diameter portions sequentially when the transfer belt runs;
a sensor to detect the marker;
a controller to control a superimposition position of the developed images on the transfer belt by a detection result outputted from the sensor; and
a secondary transferring portion to transfer secondarily the developed images superimposed on the transfer belt to a recording medium in a batch.

2. The image forming apparatus according to claim 1, wherein the marker is provided inside the side edge of the transfer belt.

3. The image forming apparatus according to claim 1, wherein the marker is provided outside a transferring area of the transfer belt.

4. The image forming apparatus according to claim 1, wherein the transfer belt is seamless and a plurality of the markers are provided on the inner surface of the transfer belt.

5. The image forming apparatus according to claim 1, wherein the transfer belt is made of polyimide.

6. The image forming apparatus according to claim 1, wherein an electric resistance VR (Ω·cm) of the transfer belt has a range as follows:
9.2≦Log₁₀VR≦10.2

7. The image forming apparatus according to claim 1, wherein the transfer belt is black.

8. The image forming apparatus according to claim 1, wherein the marker is zinc oxide particles coated flatly on the transfer belt.

9. The image forming apparatus according to claim 1, wherein the marker is printed on the transfer belt.

10. An image forming apparatus, comprising:
an image carrier;
a developing portion to form developed images of a plurality of colors on the image carrier;
an endless transfer belt installed opposite to a primary transferring position of the image carrier whereon the developed images formed on the image carrier are sequentially transferred and the developed images of the plurality of colors are superimposed;
a plurality of rollers to stretch and suspend the transfer belt;
a groove formed on the inner surface of the transfer belt;
a marker provide in the groove;
a sensor to detect the marker;
a controller to control a superimposition position of the developed images on the transfer belt by a detection result outputted from the sensor; and
a secondary transferring portion to transfer secondarily the developed images superimposed on the transfer belt to a recording medium in a batch.

11. The image forming apparatus according to claim 10, wherein the marker is provided inside the side edge of the transfer belt.

12. The image forming apparatus according to claim 10, wherein the marker is provided outside a transferring area of the transfer belt.

13. The image forming apparatus according to claim 10, wherein the transfer belt is seamless and a plurality of the markers are provided on the inner surface of the transfer belt.

14. The image forming apparatus according to claim 10, wherein the transfer belt is made of polyimide.

15. The image forming apparatus according to claim 10, wherein an electric resistance VR (Ω·cm) of the transfer belt has a range as follows:
9.2≦Log₁₀VR≦10.2

16. The image forming apparatus according to claim 10, wherein the transfer belt is black.

17. The image forming apparatus according to claim 10, wherein the marker is zinc oxide particles coated flatly on the transfer belt.

18. The image forming apparatus according to claim 10, wherein the marker is printed on the transfer belt.

19. A transfer belt, comprising:
an endless belt base whereon developed images of a plurality of colors are sequentially transferred and the developed images of a plurality of colors are superimposed;
a groove formed on the inner surface of the endless belt base; and
a marker provided in the groove.

20. The transfer belt according to claim 19, wherein the endless belt base is seamless and a plurality of the markers are provided on the endless belt base.
